(19) United States
(12) Patent Application Publication
(10) Pub. No.: US 2008/0270311 A1
(43) Pub. Date: Oct. 30, 2008

(54) Method and Apparatus for Composing a Digital Rights Management License Format

(75) Inventors: Petr Peterka, San Diego, CA (US); Alexander Medvinsky, San Diego, CA (US); Paul Moroney, Olivenhain, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/843,312

(22) Filed: Aug. 22, 2007

Related U.S. Application Data
(60) Provisional application No. 60/914,423, filed on Apr. 27, 2007.

(51) Int. Cl. G06Q 10/00

(52) U.S. Cl. 705/59; 705/51

(57) ABSTRACT

A process composes a content license for a set of content. The content license has a static portion and a dynamic portion. Further, the process inserts a master key into the static portion. In addition, the process inserts a plurality of content rule sets of values into the dynamic portion and composes a unique content encryption key for each segment of content associated with one of the content rule sets of values as each of the content rule sets of values is sequentially received during recording of the content. The unique content encryption key is based on the master key and at least a subset of the content rule set of values for a corresponding segment of the content. The unique content encryption key is utilized for encryption of each segment of the content to generate a plurality of encrypted content segments for storage on the storage medium.

### RELATED APPLICATIONS

This application claims priority to U.S. Provisional Application Ser. No. 60/914,423 entitled “IPRM License Format,” filed on Apr. 27, 2007, the content of which is incorporated herein by reference in its entirety.

### BACKGROUND

1. Field

This disclosure generally relates to the field of audio/visual content. More particularly, the disclosure relates to the management of rights associated with audio/visual content.

2. General Background

A recording device such as a Digital Video Recorder (“DVR”) records real-time content coming from sources such as cable, satellite, or broadband sources. The content generally has a content license associated with it that specifies the rights associated with the content. However, copy control information (“CCI”) updates, which change the rights for different segments of the content, may be received by the DVR as it records the content in real-time.

As a result, the content license formed initially, or in its initial state is insufficient for providing rights management for the content received with or after a CCI update. Current approaches do not adequately address the content license in view of CCI updates to provide a seamless user experience. For instance, current approaches lead to delays in the display of content during a trick play, e.g., fast forward, jump, skip, etc., or the current solutions provide a weak binding between the CCI information and the encrypted content.

### SUMMARY

In one aspect of the disclosure, a process may be utilized by a digital rights management component. The process composes a content license for a set of content. The content license has a static portion and a dynamic portion. Further, the process inserts a master key into the static portion. In addition, the process inserts a plurality of content rule sets of values into the dynamic portion and composes a unique content encryption key for each segment of content associated with one of the content rule sets of values as each of the content rule sets of values is sequentially received during recording of the content. The unique content encryption key is based on the master key and at least a subset of the content rule set of values for a corresponding segment of the content. The unique content encryption key is utilized for encryption of each segment of the content to generate a plurality of encrypted content segments for storage on the storage medium.

In another aspect, a process may be utilized by a digital video recorder. The process receives a segment of content and a content rule set of values corresponding to the segment of content. Further, the process provides the content rule set of values to a digital rights management component so that a content license is composed. The content license has a static portion and a dynamic portion. The static portion includes a master key. The dynamic portion includes the content rule set of values. In addition, the process encrypts the segment of the content with a unique content encryption key to generate an encrypted segment of content. The unique content encryption key for the segment of content is generated by the digital rights management component based on the master key and the content rule set of values. Finally, the process records the encrypted segment of content on to a storage medium.

In yet another aspect, another process may be utilized by the digital video recorder. The process receives a segment of content and a content rule set of values corresponding to the segment of content. Further, the process provides the content rule set of values to a digital rights management component so that a content license is composed. The content license has a static portion and a dynamic portion. The static portion includes a master key. The dynamic portion includes the content rule set of values. In addition, the process encrypts the segment of the content with a unique content encryption key to generate an encrypted segment of content. The unique content encryption key for the segment of content is generated by the digital rights management component based on the master key and the content rule set of values. The process 500 inserts a marker token corresponding to the unique content encryption key into an index file. The marker token includes an index and the content rule set of values associated with the unique content encryption key so that the content rule set of values associated with the unique content encryption key is retrieved during trick mode playback. Finally, the process records the encrypted segment of content on to a storage medium.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a digital rights management (“DRM”) environment.

FIG. 2 illustrates the interaction between the DVR, the content protection module, and the content source.

FIG. 3 illustrates a process that may be utilized by the DRM component.

FIG. 4 illustrates a process that may be utilized by the DVR.

FIG. 5 illustrates another process that may be utilized by the DVR.

FIG. 6 illustrates a block diagram of a station or system that generates a DRM license format.

### DETAILED DESCRIPTION

A method and apparatus are disclosed that provide for composing a DRM license format. An extendable DRM license format is provided so that an extendable DRM license may be composed to include information that is known at the beginning of a recording of content and add information that is determined as the recording progresses. Accordingly, the DRM license format includes a static portion and a dynamic portion. The static portion includes the information that is known at the beginning of the recording whereas the dynamic portion includes information that is added during the recording as information is received.

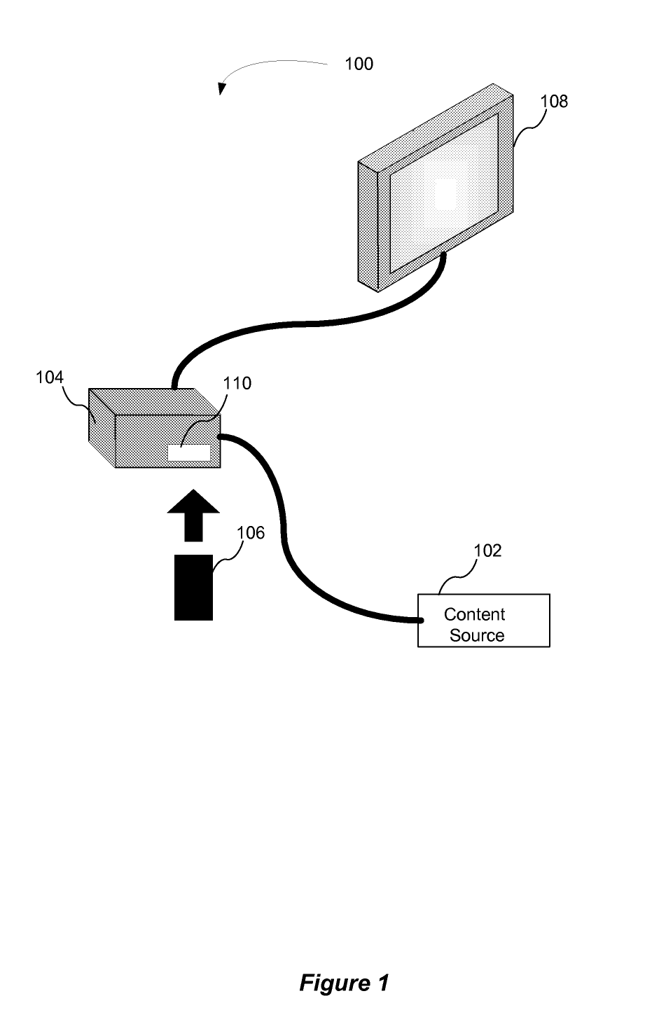

FIG. 1 illustrates a DRM environment 100. A content source 102, such as a content provider, encrypts a set of content and then sends the content through a transmission line, e.g., a cable, to a DVR 104, which has a DRM system. If the content is encrypted, the DVR 104 sends the content to a content protection module 106 for decryption. Examples of the content protection module 106 include a CableCARD®, secure memory card, on-board security chip, etc. However, any component that has the capability of terminating conditional access that was protecting content transmitted to a DVR 104 and applying copy protection when sending the content to the set top box 104 may be considered a content protection module 106. Alternatively, the DVR 104 may receive content that is streamed from a device in a home network. Further, the DVR 104 is utilized as an example, and one of ordinary skill in the art will recognize that any type of device, such as a mobile phone, television with a built-in slot for a CableCARD®, secure card, subscriber identity module (“SIM”) card, etc., may be utilized. The content protection module 106 then decrypts the content. Further, in one embodiment, the content protection module 106 has an interface so that it may fit into a slot 110 of a DVR 104 and communicate with the DVR 104.

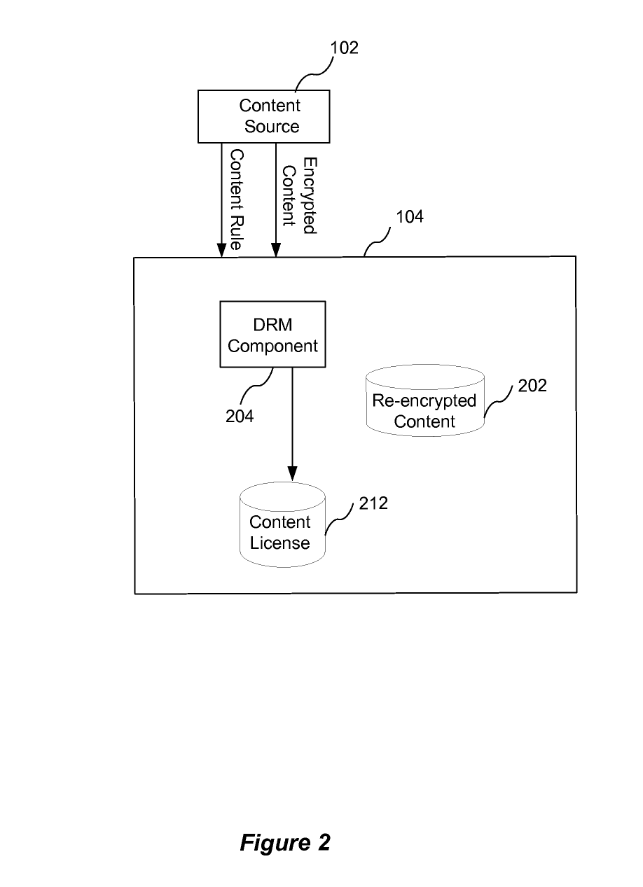

FIG. 2 illustrates the interaction between the DVR 104, the content protection module 106, and the content source 102. When the DVR 104 receives encrypted content from the content source 102, the DVR 104 may also receive one or more content rules, e.g., CCI information, from the content source 102. The DVR 104 requests that the content protection module 106 decrypts the content so that the DVR 104 may re-encrypt the content and record the re-encrypted content by storing it on a hard drive 202. CCI may include traditional copy control information such as Encryption Mode Indicator (“EMI”), Analog Protection System (“APS”), Constrained Image Trigger (“CIT”), Copy Generation Management System-Analog (“CGMS-A”), etc., extended CCI (including rental information, counted playbacks, etc., or other relevant content attributes such as the content resolution (e.g., HD vs. SD).

The DVR 104 has a DRM component 204 that composes a content license associated with the content. The content license may be stored on a storage medium 212. The DRM component 204 inserts a master key into the content license. As CCI updates are received for different segments of the content, the DRM component generates a unique content encryption key (“CEK”) for each segment that is utilized to re-encrypt the content for storage on the hard drive 202 and to decrypt the re-encrypted content during playback. In one embodiment, the DRM component 204, for each segment, stores a portion of the CCI update information. The DRM component 204 composes, and later derives, the CEK for each segment by a calculation involving the master key and a subset of the content rule associated with the segment. As an example, the subset of the content rule may include bits that are selected from the CCI information. Accordingly, the DRM component 204 may maintain a list of CCI bits associated with a set of content. Each entry in the list of CCI bits may be associated with an index that is incremented sequentially as each set of CCI bits is received. Alternatively, the index may be a random number used as a Content Key Identifier (“CKID”).

In one embodiment, the static portion of the content license includes the master key. Further, the static portion may include the start time of the recording. Optionally, the static portion may include a name or an identifier of the content. Finally, the static portion may also identify the content source 102. The optional name or identifier of the content allows the DVR 104 to correctly pair the content with the corresponding content license composed by the DRM component 204. Further, knowledge of the content source 102 that provides the content is helpful to the DVR 104 in determining any policies that are particular to the type of content source 102 that provides the content as policies may vary from one type of content source 102 to another. One of ordinary skill in the art will recognize that a subset of the content of the static portion listed above and/or additional information may be utilized for the static portion. The static portion of the content license is composed at the beginning of the recording and does not change as the recording progresses.

In one embodiment, the dynamic portion of the content license includes a list of sets of CCI information, an index associated with each CCI set, a time stamp associated with each CCI set, and expiration of the segment associated with a particular CCI set. If the content rule indicates that a particular segment is copy never, the content cannot be recorded other than on a temporary basis (pause). In that case, the expiration may indicate that each segment, e.g., ten minutes, of the content stored in a temporary buffer is usable for a predetermined time period, e.g., ninety minutes, and that trick plays may be performed for the time that the content in the temporary buffer is usable. In other words, the expiration indicates a time up until which the key associated with the particular segment can be utilized to decrypt the particular segment.

The content license therefore includes time stamps associated with the individual segments of the content (and possibly different CCI values) so that each segment of the content can be expired separately. At a particular moment in time, it may be that only the initial part of the copy never content has expired whereas the rest of that recording is still playable. Accordingly, a playback of a particular segment may be performed from the segment timestamp and up to the timestamp plus the copy never buffer size. Preferably, each segment timestamp is a relative offset from the beginning of the recording and an absolute timestamp can be recreated when the offset is combined with the start time of the recording in the static portion. Alternatively, a playback of a particular segment may be performed from the start time of the recording to the time of the time stamp.

In another embodiment, the dynamic portion also includes content resolution information, which may be utilized to limit the copying of certain types of content. For instance, High-Definition (“HD”) content may not be allowed to be copied to a portable device.

The list that is maintained in the dynamic portion of the content license may be stored in a variety of data structures. For instance, a dynamic array may be utilized. An example of a configuration utilizing an MPEG-2 stream may have a dynamic array with an odd/even key indicator (also called Scrambling Control) so that transitions between keys do not cause any picture disruption. The odd/even key may be the last bit of the index or a separate odd/even key indicator.

In one embodiment, sequential playback of the content is effectuated by DRM component 204 remembering the last CCI element set of values utilized. Each time that the DRM component 204 is asked to derive a new CEK and to set CCI values for protected outputs, the DRM component 204 selects the next consecutive CCI element set of values.

In another embodiment, playback in trick mode is effectuated utilizing a marker token stored in an index file. Recorded content is usually accompanied by an index file that contains data about significant information and events, e.g., location of I-frames, changes in the program map table (“PMT”), etc. In one embodiment, a marker token is added to the index file (or a similar file) that signals an upcoming key change. The marker token includes the index and the CCI bits and any other attributes used in deriving the CEK and setting output control, e.g., a time stamp. Accordingly, when a user requests a fast forward, rewind, or jump to a particular portion of the content, the DVR 104 can look in the index file to find the current index and CCI values to provide to the DRM component 204. The DRM component 204 may then derive the CEK for the segment that the user wishes to fast forward, rewind, or jump to by utilizing the CCI value and the master key. As a result, the user is provided with a glitchless viewing experience irrespective of whether the playback is in sequential mode or trick play mode.

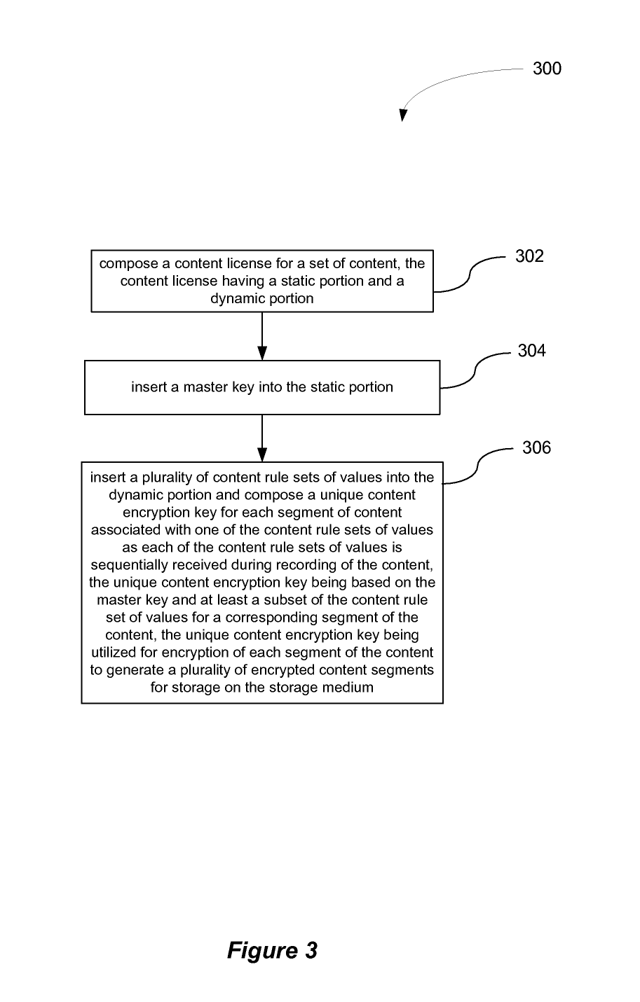

FIG. 3 illustrates a process 300 that may be utilized by the DRM component 204. At a process block 302, the process 300 composes a content license for a set of content. The content license has a static portion and a dynamic portion. Further, at a process block 304, the process 300 inserts a master key into the static portion. In addition, at a process block 306, the process 300 inserts a plurality of content rule sets of values into the dynamic portion and composes a unique content encryption key for each segment of content associated with one of the content rule sets of values as each of the content rule sets of values is sequentially received during recording of the content. The unique content encryption key is based on the master key and at least a subset of the content rule set of values for a corresponding segment of the content. The unique content encryption key is utilized for encryption of each segment of the content to generate a plurality of encrypted content segments for storage on the storage medium.

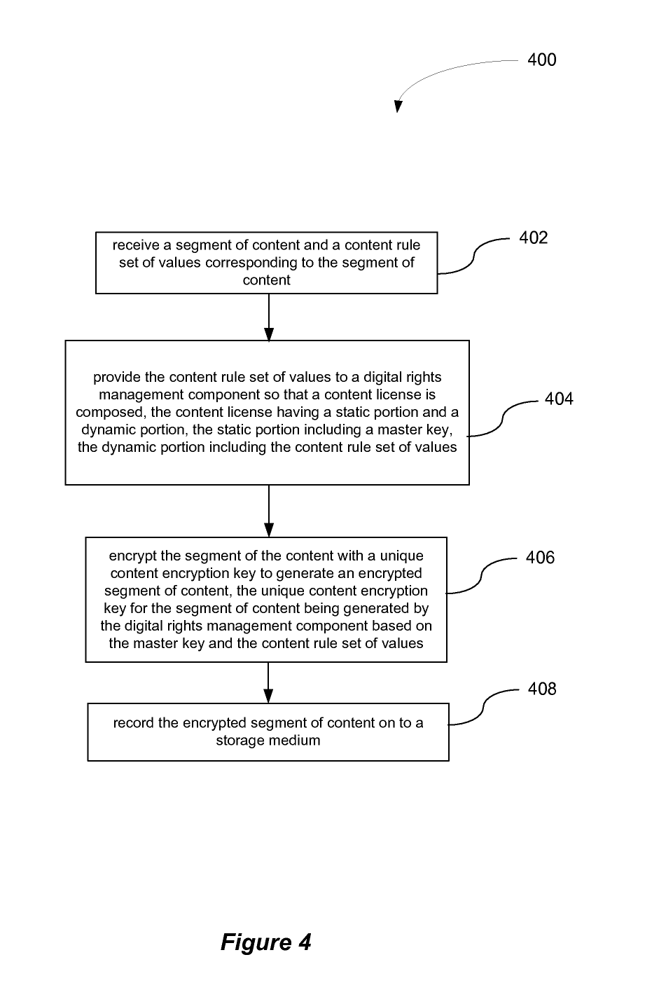

FIG. 4 illustrates a process 400 that may be utilized by the DVR 104. At a process block 402, the process 400 receives a segment of content and a content rule set of values corresponding to the segment of content. Further, at a process block 404, the process 400 provides the content rule set of values to a DRM component 204 so that a content license is composed. The content license has a static portion and a dynamic portion. The static portion includes a master key. The dynamic portion includes the content rule set of values. In addition, at a process block 406, the process 400 encrypts the segment of the content with a unique content encryption key to generate an encrypted segment of content. The unique content encryption key for the segment of content is generated by the DRM component 204 based on the master key and the content rule set of values. Finally, at a process block 408, the process 400 records the encrypted segment of content on to a storage medium.

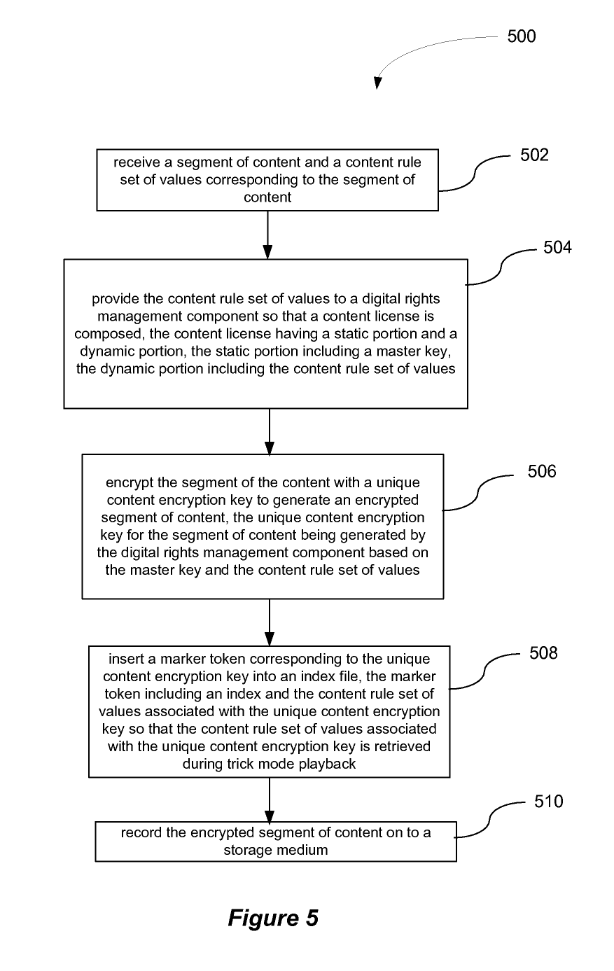

FIG. 5 illustrates another process 500 that may be utilized by the DVR 104. At a process block 500, the process 502 receives a segment of content and a content rule set of values corresponding to the segment of content. Further, at a process block 504, the process 500 provides the content rule set of values to a DRM component 204 so that a content license is composed. The content license has a static portion and a dynamic portion. The static portion includes a master key. The dynamic portion includes the content rule set of values. In addition, at a process block 506, the process 500 encrypts the segment of the content with a unique content encryption key to generate an encrypted segment of content. The unique content encryption key for the segment of content is generated by the DRM component 204 based on the master key and the content rule set of values. At a process bock 508, the process 500 inserts a marker token corresponding to the unique content encryption key into an index file. The marker token includes an index and the content rule set of values associated with the unique content encryption key so that the content rule set of values associated with the unique content encryption key is retrieved during trick mode playback. Finally, at a process block 510, the process 500 records the encrypted segment of content on to a storage medium.

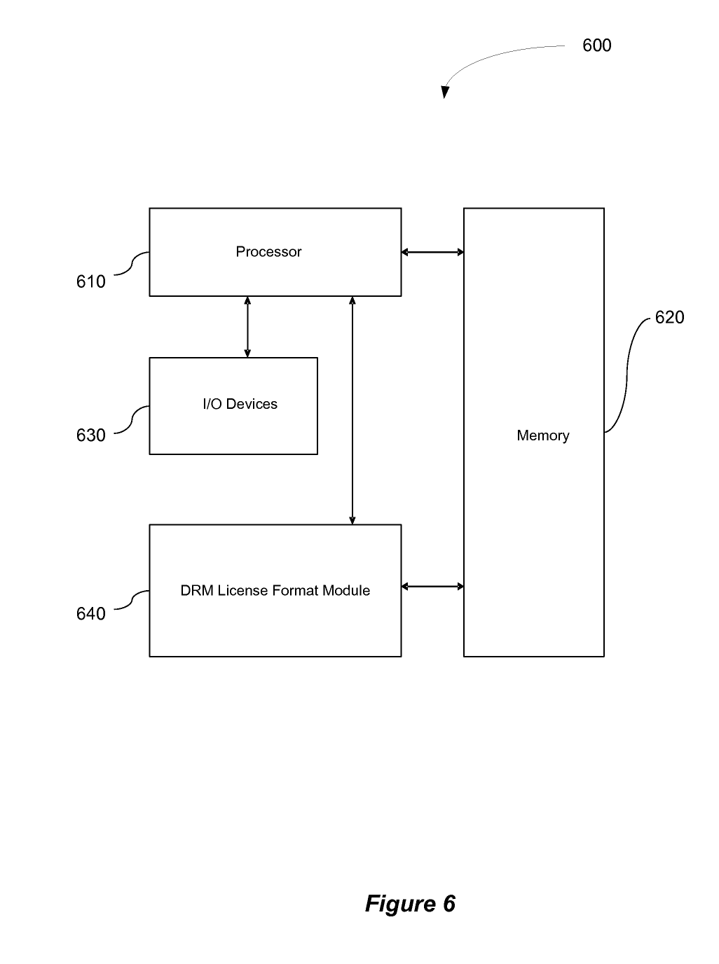

FIG. 6 illustrates a block diagram of a station or system 600 that generates a DRM license format. In one embodiment, the station or system 600 is implemented using a general purpose computer or any other hardware equivalents. Thus, the station or system 600 comprises a processor 610, a memory 620, e.g., random access memory (“RAM”) and/or read only memory (ROM), a DRM license format module 640, and various input/output devices 630, (e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)). The DRM license format module 640 may include one or more processors, and/or corresponding code.

It should be understood that the DRM license format module 640 may be implemented as one or more physical devices that are coupled to the processor 610 through a communication channel. Alternatively, the DRM license format module 640 may be represented by one or more software applications (or even a combination of software and hardware, e.g., using application specific integrated circuits (ASIC)), where the software is loaded from a storage medium, (e.g., a magnetic or optical drive or diskette) and operated by the processor in the memory 620 of the computer. As such, the DRM license format module 640 (including associated data structures) of the present disclosure may be stored on a computer readable medium, e.g., RAM memory, magnetic or optical drive or diskette and the like.

It is understood that the DRM license format approach described herein may also be applied in other types of systems. Those skilled in the art will appreciate that the various adaptations and modifications of the embodiments of this method and apparatus may be configured without departing from the scope and spirit of the present method and system. Therefore, it is to be understood that, within the scope of the appended claims, the present method and apparatus may be practiced other than as specifically described herein.

We claim:

1. A method comprising:
composing a content license for a set of content, the content license having a static portion and a dynamic portion;
inserting a master key into the static portion; and
inserting a plurality of content rule sets of values into the dynamic portion and composing a unique content encryption key for each segment of content associated with one of the content rule sets of values as each of the content rule sets of values is sequentially received during recording of the content, the unique content encryption key being based on the master key and at least a subset of the content rule set of values for a corresponding segment of the content, the unique content encryption key being utilized for encryption of each segment of the content to generate a plurality of encrypted content segments for storage on the storage medium.

2. The method of claim 1, wherein the storage medium is associated with a digital video recorder.

3. The method of claim 1, wherein the subset of the content rule set includes one or more copy protection bits.

4. The method of claim 1, wherein the static portion also includes a start time at which recording of the content begins.

5. The method of claim 1, wherein the static portion also includes a content name.

6. The method of claim 1, wherein the static portion also includes a content source identifier to identify from which source the content was received.

7. The method of claim 1, wherein the dynamic portion also includes a list of the plurality of content rule sets and an index associated with each content rule set in the list.

8. The method of claim 7, wherein the list is stored in a dynamic array.

9. The method of claim 1, wherein the dynamic portion also includes a start of recording timestamp for each corresponding segment of the content.

10. The method of claim 1, wherein the dynamic portion also includes, for each segment, an expiration time for the corresponding segment.

11. The method of claim 1, wherein the dynamic portion also includes, for each segment, content resolution information for the corresponding segment.

12. A method comprising:
receiving a segment of content and a content rule set of values corresponding to the segment of content;
providing the content rule set of values to a digital rights management component so that a content license is composed, the content license having a static portion and a dynamic portion, the static portion including a master key, the dynamic portion including the content rule set of values;
encrypting the segment of the content with a unique content encryption key to generate an encrypted segment of content, the unique content encryption key for the segment of content being generated by the digital rights management component based on the master key and the content rule set of values; and
recording the encrypted segment of content on to a storage medium.

13. The method of claim 12, further comprising decrypting the encrypted segment of content during playback with the unique content encryption key.

14. The method of claim 12, wherein the storage medium is associated with a digital video recorder.

15. The method of claim 12, wherein the content rule set of values includes one or more copy protection bits.

16. A method comprising:
receiving a segment of content and a content rule set of values corresponding to the segment of content;
providing the content rule set of values to a digital rights management component so that a content license is composed, the content license having a static portion and a dynamic portion, the static portion including a master key, the dynamic portion including the content rule set of values;
encrypting the segment of the content with a unique content encryption key to generate an encrypted segment of content, the unique content encryption key for the segment of content being generated by the digital rights management component based on the master key and the content rule set of values;
inserting a marker token corresponding to the unique content encryption key into an index file, the marker token including an index and the content rule set of values associated with the unique content encryption key so that the content rule set of values associated with the unique content encryption key is retrieved during trick mode playback; and
recording the encrypted segment of content on to a storage medium.

17. The method of claim 16, further comprising decrypting the encrypted content segment associated with a trick play during trick mode playback with the unique content encryption key.

18. The method of claim 17, wherein the content segment associated with a trick play is a content segment to which a user provides a rewind instruction.

19. The method of claim 17, wherein the content segment associated with a trick play is a content segment to which a user provides a fast forward instruction.

20. The method of claim 17, wherein the content segment associated with a trick play is a content segment to which a user provides a jump instruction.
